(19) United States
(12) Patent Application Publication
(10) Pub. No.: US 2004/0201702 A1
(43) Pub. Date: Oct. 14, 2004

(54) Automatic location identification and categorization of digital photographs

(76) Inventor: Craig R. White, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/983,288

(22) Filed: Oct. 23, 2001

(51) Int. Cl. H04N 5/225

(52) U.S. Cl. 348/207.99

(57) ABSTRACT

The invention is a system for automatically categorizing images from a user. The user may take images with a digital camera with image data stored along with the images. The image data may include location and times data. The location data may be provided through an installed GPS module. The user may transfer the images and image data to an image processing service. The image processing service may include a location database for pinpointing the specific or precise location that the image was captured. The image data may be used to categorize the images. Categorization may be configured in a user requested hierarchal organization scheme. Once the images are categorized, the picture processing service may present that information to the user in web page format.

### FIELD OF THE INVENTION

This invention relates generally to an automatic categorization system for image data and more particularly to a categorization system that utilizes stored location data for processing images.

### DESCRIPTION OF THE RELATED ARTS

Recently, digital cameras have become widely used. A primary reason for the increased use is the various features offered by these digital devices that were not available in earlier cameras. One such feature is the ability to digitally store image data that can be used in other electronic devices and software applications.

Stored image data can be directly transferred onto personal computers and computer network systems where the image data can be processed. Computer processing activities may include, storing, filing, editing, printing etc. Because computer systems provide these functions, many businesses that provide photography and imaging services have integrated computer network systems into their business practice. These services are useful both to those people who have computer and network access, and also to those who do not have this access.

To those people who do not have access to computer networks, there is a need for photography and imaging services. A customer can physically take her stored images to an imaging service business for processing.

To those that do have access to computer networks, the image service providers are still needed because they are time efficient and can provide speedy automatic results. Customers can therefore access the image service providers from a computer at a remote location. In this respect, network-related image services have been especially beneficial because a customer can order a print from her home and/or the office without visiting a store or by using a delivery service.

There are several other functions typically associated with network related photographic and imaging services. Files are usually stored according to the network capabilities and/or customer information. Typically, images are stored based on a customer's identity and/or billing information. This categorization is generally used to associate the images with a specific customer.

A disadvantage of network categorization systems is that generally they do not automatically categorize stored images according to stored data that distinguishes images based on variable image information such as specific location data, time data etc. For example, if a tourist takes pictures during a tour of various amusement parks, and the pictures are developed, the tourist may be unable to recognize the specific locations in the amusement parks at which each photo was taken. Also, the tourist may not be able to recall the dates and times at which the photos were taken. The tourist' trip may also result in large quantities of digital images that are not organized, categorized, labeled, or identified in any way.

Digital cameras that store and categorize general location data are disclosed in U.S. Pat. No. 5,506,644. The U.S. Pat. No. 5,506,644 patent discloses a camera that can fetch position information representing a place of photography. However, the location information of is too general and is not helpful when many photos are all taken within close proximity of each other.

### SUMMARY OF THE INVENTION

In one respect, the invention utilizes an automatic categorization arrangement for use with a digital camera. In this respect, the digital camera stores images and associated image data. In particular, the arrangement includes a computer station and a network connected to the computer station. The automatic categorization arrangement also includes an image processing service connected to the network. The image processing service has a specific location processing module that is configured to automatically categorize and label the stored images. The stored images are categorized based on a specific location where the image was captured.

In another respect, the invention relates to a method for categorizing images stored in a digital camera using a categorizing arrangement. The method includes the step of downloading the stored images and associated image data into the categorizing arrangement. The method for categorizing the stored images also includes the step of identifying specific locations that images were captured. The method further includes the categorizing and labeling the images. The images are categorized and labeled based on the specific locations where the images were captured.

In yet another respect, the invention pertains to an automatic image categorization system. In this respect, the system includes a computer station and a digital camera connectable to the computer station. The digital camera stores images and associated image data. The system also includes a network connected to the computer station and an image processing service connected to the network. The digital camera has stored images and associated image data stored within. Also, the image processing service comprises a specific location processing module configured to categorize and label the images based on the specific location where the image was captured.

In comparison to known prior art, certain embodiments of the invention are capable of achieving certain aspects, including some or all of the following: the automatic identification of where an image is taken; the automatic categorization of photos, and the flexibility to categorize the photos using different criteria. Those skilled in the art will appreciate these and other aspects of various embodiments of the invention upon reading the following detailed description of a preferred embodiment with reference to the below-listed drawings.

### BRIEF DESCRIPTION OF THE DRAWINGS

FIG. 1 illustrates a schematic of a digital camera connected to a computer station according to a first exemplary embodiment of the invention;

FIG. 2 is a block diagram of the digital camera according to the first exemplary embodiment of the invention;

FIG. 3 illustrates a block diagram of a categorization system according to the first exemplary embodiment of the invention;

FIGS. 4A and 4B are exemplary illustrations of the specific location processor of FIG. 3;

FIG. 4C is an exemplary illustration of a location database of FIG. 4A and 4B; and

FIG. 5 is an exemplary flow chart showing a mode of operation of the categorization system;

### DETAILED DESCRIPTION OF A PREFERRED EMBODIMENT

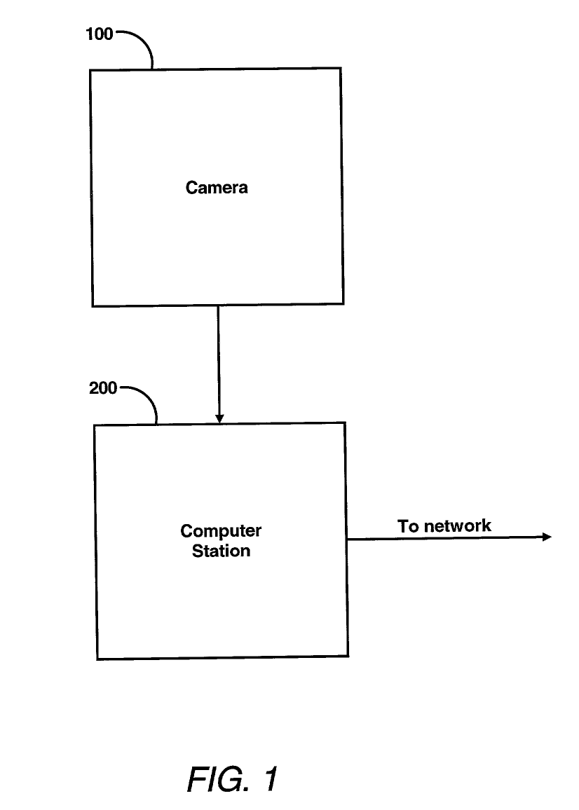

FIG. 1 illustrates an exemplary schematic of a digital camera 100 connected to a computer station 200 according to a first embodiment of the invention. The term “connected” as used herein and throughout the entire disclosure, means connected directly or indirectly through an intermediate element. The camera 100 is used to capture images and associated image data. The images and associated image data may be stored in the camera 100. The stored images and associated image data may be downloaded onto the computer station 200. The computer station 200 may perform processing functions such as editing, cropping, dithering, etc., on the stored images and image data. This may be accomplished via a network.

The camera 100 may be connected to the computer station 200 directly or indirectly through an intermediate element. The connection may be wired or wireless. Typically, according to the mode of operation, the computer station 200 may be a personal computer or a kiosk at a hotel or tourist attraction or the like. The computer station 200 may also be a personal computer at a user's home or office.

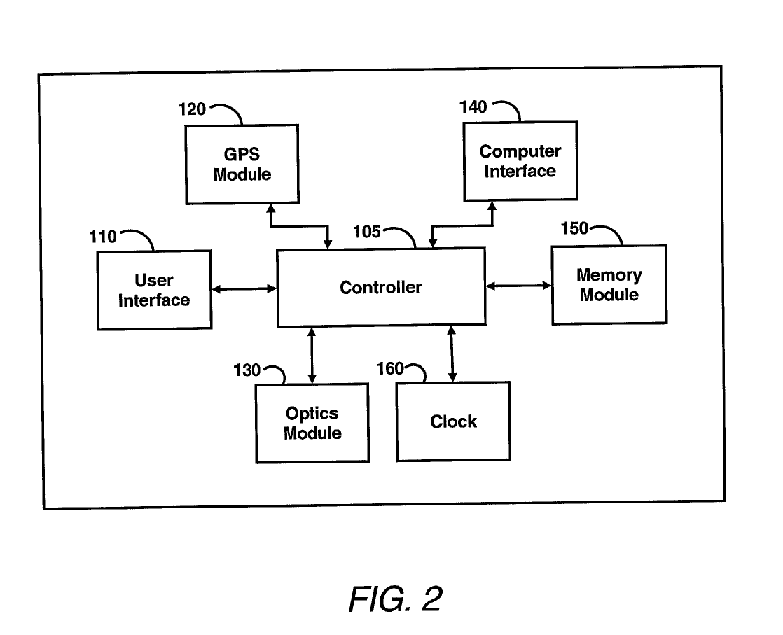

FIG. 2 is an exemplary block diagram of the digital camera 100 in accordance with the principles of the present invention is illustrated. The camera 100 includes several different modules connected to a controller 105. The controller 105 may control the overall functions of the camera 100. As illustrated in FIG. 2, the camera 100 may also include a user interface 110, an optics module 130, a Global Positioning System (GPS) module 120, a computer interface 140, and a memory module 150.

The user interface 110 may provide the capability to receive commands from a user. The user interface 110 may include a display such as a Liquid Crystal Display (LCD) (not shown) and/or a plurality of alphanumeric keys or switches for permitting a user to communicate with the camera 100. The user interface 110 may also provide the capability to enter user-configuration information, such as user preferences and/or codes. The user interface 110 may also provide secure access, thereby providing camera security. In this respect, the camera 100 would associate a password with a user, so that the password must first be entered via the user interface 110, before the user can operate the camera 100.

The optics module 130 may be configured to capture images. The optics module 130 may include circuitry to operate image-capturing elements such as lenses and image recording medium. The images may be recorded and stored on a chip or on any other known means.

The controller 105 may be configured to interface with the GPS module 120. The GPS module 120 may be configured to provide location data for captured images. Location data provided by the GPS is stored in the camera memory module 150 along with each captured image. The camera may also have a clock module 160 for providing the time data, i.e., the time and date when images are captured.

The computer interface 140 of the digital camera 100 provides an interface with the computer station 200. The computer station 200 may access data stored in the camera 100 via the computer interface 140. The connection between the camera 100 and computer station 200 via the computer interface 140 may be wired or wireless. Wireless connections may include Blue Tooth technology, infrared or radio frequency protocols. The controller 105 may be further configured to interface with the memory module 150 wherein image data is stored. Apart from the storage of conventional image data, the memory module 150 may provide storage for the location data provided by the GPS service, and time data provided by the clock module 160. Additional data, which may be automatically captured by the camera 100 or entered by a user via the interface 110, may also be stored in the memory module 150. This data may include weather conditions data, or any other data within the scope of the invention.

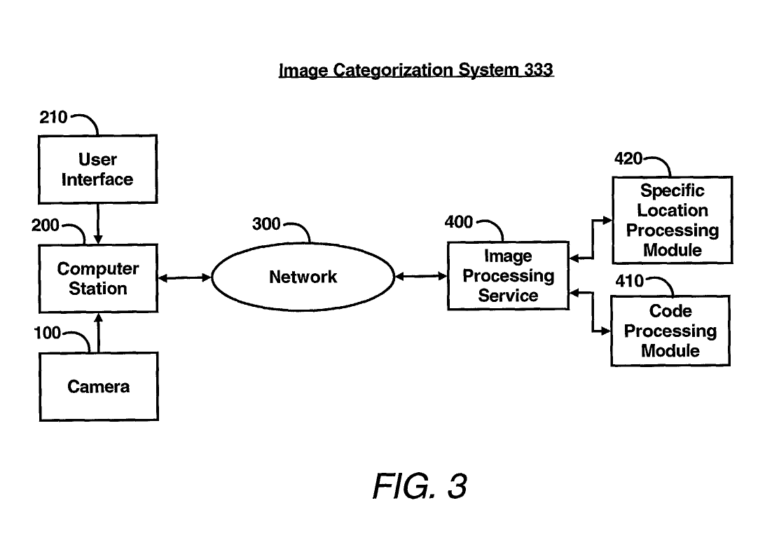

FIG. 3 illustrates a schematic of a categorization system 333 according to a first embodiment of the invention. FIG. 3 also shows the camera 100 connected to the computer station 200 for downloading stored camera data for processing and categorizing by the system. The computer station 200 may also be provided with a user interface 210 such as a keyboard for entering user data or codes. A wide variety of user information and requests may be entered including user name, address, phone number, the number of images requested, a profile of people photographed, a particular web page layout for displaying images, printing requests, deleting requests, etc. A user may also enter categorization preferences requesting a specified categorization field. These preferences are outlined in greater detail below.

FIG. 3 also shows a network 300 connected to the computer station 200. The network 300 provides connection to the categorization services for the data transferred from the camera 100 to the computer station 200. Generally, the network 300 may include a local area network (LAN), wide area network (WAN), personal area network (PAN), private or public networks including the Internet, and the like. LANs may include wired or wireless networks.

As illustrated in FIG. 3, the network 300 is connected to an image processing service 400. The image processing service 400 performs the processing and categorization services. The images may be categorized in fields such as general location or specific location in accordance with the stored location data obtained from the camera 100. The categorization of data may also be performed according to other stored data such as time data or additional information entered by a user.

The image processing service 400 includes a code processing module 410 and a specific location processing module 420 as illustrated in FIG. 3. The code processing module 410 and the specific location processing module 420 may be included as software within the image processing service 400. Alternatively, the code processing module 410 and the specific location processing module 420 may be separate processors remote from the image processing service 400.

The code processing module 410 categorizes the stored images based on the image data or codes downloaded with the stored images. This data may include GPS location data, time data (stamps), or any other stored data including user information or codes. Therefore, the code processing module 410 may categorize the images based on general geographic location such as the continent or country or state, for example. The code processing module 410 may also categorize the images based on the date and time that they were taken, or any other entered user information. The code processing module 410 may categorize the images based on a plurality of categories at the same time according to a desired hierarchy. The code processing module may also label each image with corresponding data from desired categories.

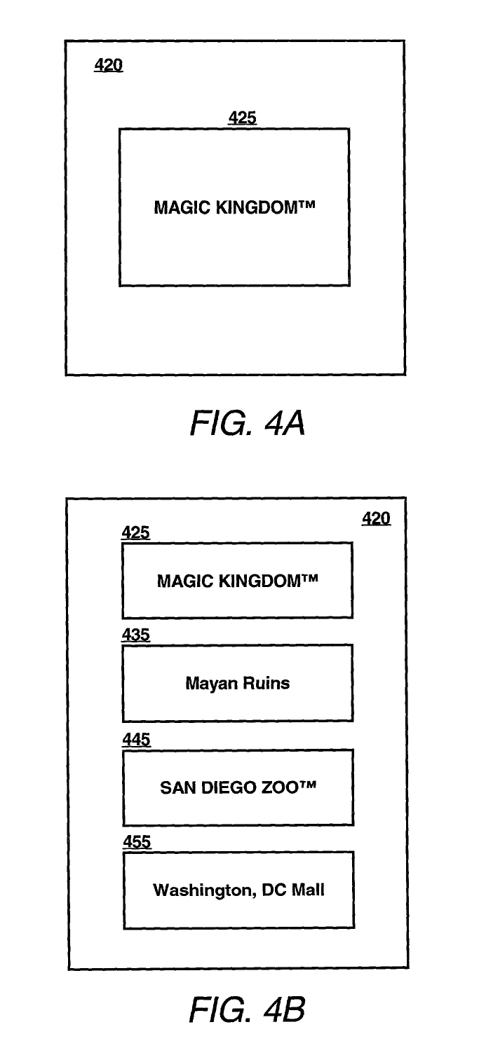

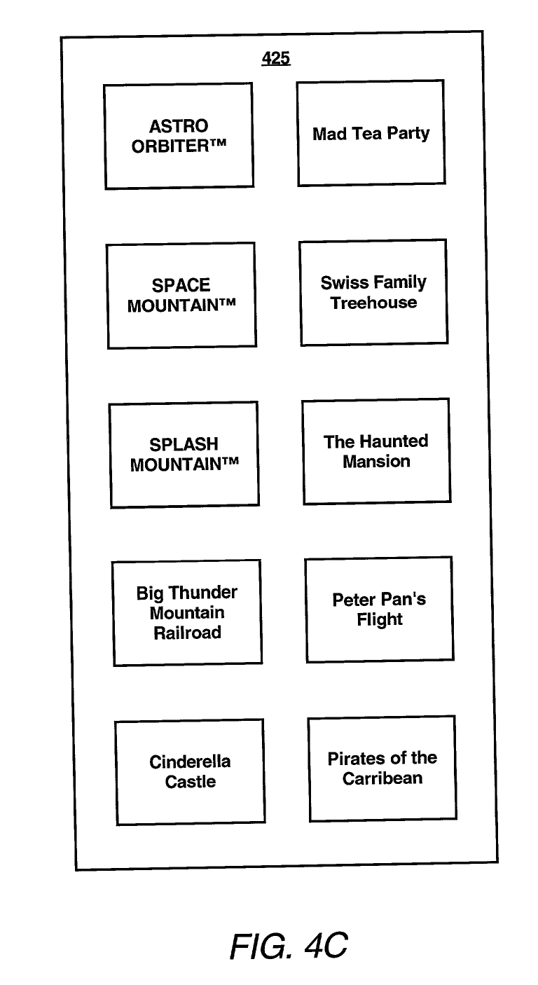

FIGS. 4A and 4B are exemplary illustrations of the specific location processing module 420. The specific location processing module 420 contains at least one location database that provides specific location information. The specific location data refers to a precise location at which an image is captured. The specific location processing module 420 may be used to identify the specific location where an image was captured. Based on this information, the specific location processing module 420 may further categorize the images. FIG. 4A shows a specific location processing module 420 with one location database, a Disney's MAGIC KINGDOM ™ database 425. FIG. 4B shows a specific location processing module 420 with a plurality of location databases, the MAGIC KINGDOM ™ database 425, a Mayan Ruins database 435, a SAN DIEGO ZOO ™ database 445 and a Washington D.C. Mall database 455. It should be understood that any other desired location database besides those specifically mentioned might be included in the specific location processor 420.

The specific location processor 420 identifies the specific or precise location at which an image was captured based on the associated GPS location data and information provided by the location databases 425, 435, 445, etc. In the case of multiple location databases (as illustrated in FIG. 4B) the stored GPS location data is also used to select the appropriate database. Further details of the operation of the specific location processing module 420 are discussed below.

FIG. 4C is an exemplary illustration of the location database 425 of FIGS. 4A and 4B. FIG. 4C shows some of the more specific locations that can be identified by the MAGIC KINGDOM ™ database 425. As stated above, the specific location processor 420 determines the specific or precise location at which an image was captured. For example, as illustrated in FIG. 4C, the system could determine if an image was captured at SPACE MOUNTAIN ™, or SPLASH MOUNTAIN ™, or any other specific location in the MAGIC KINGDOM ™ database 425. The images may then be categorized according to these determinations. Each image may then be labeled with the determined specific location.

The location processor 420 may include electronics that recognize the GPS coordinates saved with each image. Each location database (such as 425) may have a table that indexes the GPS coordinates with a corresponding specific location. For example, the MAGIC KINGDOM ™ database 425 would index a stored GPS location data with the corresponding attraction location, such as Peter Pan's Flight, The Haunted Mansion, or SPLASH MOUNTAIN ™, etc.

The image processing service 400 may also provide dynamic categorization of data. The image processing service 400 may map the time data and specific location data to a specific activity that was performed at that time and location. Therefore the image processing service 400 may have access to activity schedules for specific locations and use the activity schedules to determine activities performed at designated times. For example, if the specific location processing module determines that an image was captured at a theater in an amusement park, the image processing service may determine from a theatre schedule, the show being performed at the theatre at the date and time the image was captured. The image may also be labeled with this information.

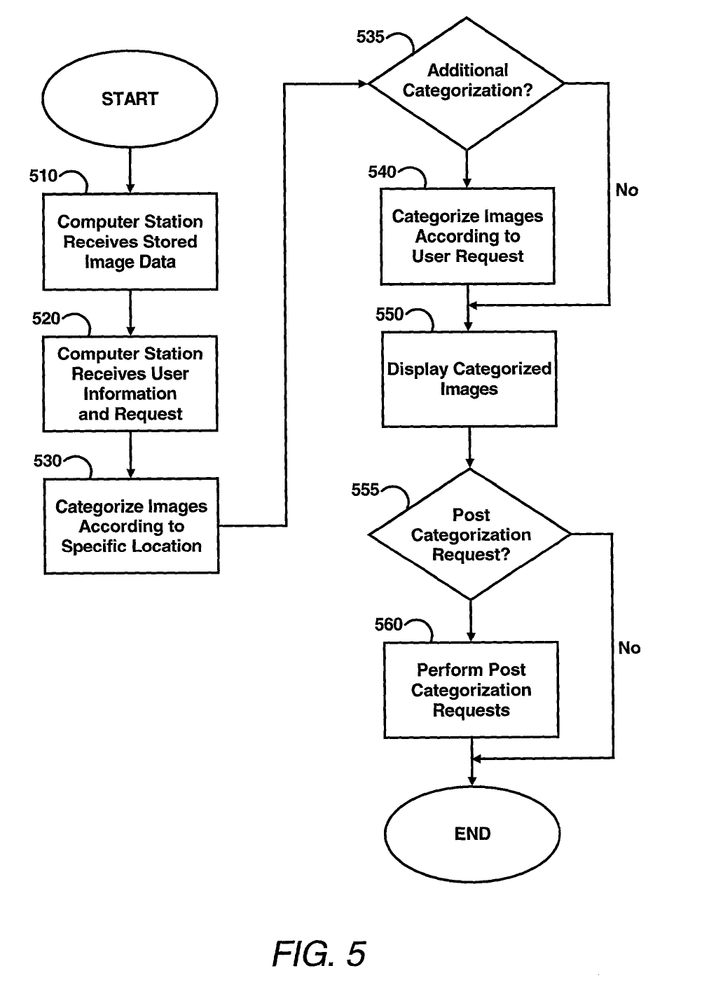

FIG. 5 is an exemplary flow chart showing a mode of operation of the categorization system 333. As illustrated in FIG. 5, in step 510, the computer station 200 receives images and associated image data from the camera 100. The transfer of data from the camera 100 to the computer station 200 may be accomplished via direct or indirect connections through intermediate elements. The transfer may be effected by automatic wireless access in which the computer station is at a remote location. The application of wireless protocol standards to this invention allows automatic connection of the camera 100 to the computer station 200 without user intervention. For example, a user may automatically download images and associated image data to a remote computer station 200 for storage and/or processing. Also, the images and associated image data may be downloaded to a previously specified Internet service for storage.

The image data may include data that is automatically stored and associated by the camera, such as GPS location coordinates or time data. Data entered via the camera user interface 110 may also be included. This data may include user name, address data, weather data or data pertaining to an occasion, such as vacation, honeymoon, business trip, etc.

At step 520, the computer station 200 may receive additional user data and requests. The additional user data may be entered via the user interface 210 associated with the computer station 200. Again, this may include data such as user name, address data, weather data or data pertaining to the occasion (such as vacation, honeymoon, business trip, etc).

User requests may also be entered via the computer station's user interface 210. Typically, a specific type of categorization may be requested. For example, a user may want the stored images to be categorized according to the general location that the image was captured, i.e., the continent, country, or state at which the image was captured. A user may further request categorization according to the time and date the images were captured. A user may also request categorization based on a plurality of categories with a hierarchical preference entered. A user may also enter via the interface 210, user preferences as to the format for displaying the images after they are categorized. A user may also enter other options for the images such as fax and e-mail requests. The user may also specify a set of defaults for categorization at initial setup time that are stored as part of the image processing service. This enables downloading of new images without user intervention.

At step 530, the picture processing service 400 automatically categorizes the images according to specific location using the specific location processing module 420. The specific location processing module 420 may contain a single location database or a plurality of location databases as illustrated in FIGS. 4A and 4B. In both scenarios, the specific location processing module 420 compares the GPS coordinates with specific location data in the database system. By performing this indexing function, a specific location corresponding to the GPS coordinates is found. The images may be labeled with the specific location data. The image processing service 400 then uses this information to categorize the images.

For example, if a user took images at MAGIC KINGDOM ™ and downloaded the images and associated image data to the categorization system 333, the GPS coordinates would match a location in the database 425. By indexing through the database 425, a determination would be made as to whether the images were taken at SPACE MOUNTAIN ™, SPLASH MOUNTAIN ™, The Haunted Mansion or any other relevant location. After determining where the images were taken, the images may be categorized and labeled by the specific location processing module 420.

At step 530, the image processing service 400 may also map the time data, and specific location data to a specific activity that was performed at that time, date and place. The image processing service 400 may have access to activity schedules for specific locations and use the activity schedules to determine activities performed at designated times. The images may also be labeled with the activity data.

At step 535, a determination is made as to whether additional categorizing is needed based upon user requests. If the answer is NO, the images are displayed in step 550. If the answer is YES, the images are categorized according to the user's request at step 540. As previously described, the images may be categorized by general location, time and date, weather conditions, or by any other requested category. Categorization according to these data fields is performed by the code processing module 410. Categorization by a plurality of categories may be requested with a preferred hierarchy. The images may be labeled with associated data from the different categories.

After the categorization at step 540, the images are displayed at step 550. Typically at step 550, the images are displayed in a web page format and the user according to information entered at step 520 may decide another display format.

At step 555 a determination is made as to whether there are any post display requests. If the answer is NO, then the process ends. If the answer is YES, then the post-displaying requests are performed. The post displaying requests may include electronic mailing and faxing options. A user may request to have particular images e-mailed or faxed to specific persons. For example, after categorizing pictures from a MAGIC KINGDOM ™ vacation, a user may request to have all the ASTRO ORBITER ™ pictures e-mailed to person A and all the Haunted Mansion pictures faxed to person B. After all these requests are performed, the process ends.

What has been described and illustrated herein are preferred embodiments of the invention along with some variations. The terms, descriptions and figures used herein are set forth by way of illustration only and are not meant as limitations. For instance, with respect to the location processor 420, any location database not specifically mentioned may be used to provide specific location information. Also, with respect to the categorization of the images, a user may request any type of categorization, in addition to the automatic location categorization. Those skilled in the art will recognize that many variations are possible within the spirit and scope of the invention, which is intended to be defined by the following claims and their equivalents, in which all terms are meant in their broadest reasonable sense unless otherwise indicated.

What is claimed is:

1. An automatic categorization arrangement for use with a digital camera having images and associated image data stored therein, the arrangement comprising:
a computer station;
a network connected to the computer station; and
an image processing service connected to the network, wherein the image processing service further comprises a specific location processing module configured to automatically identify, categorize, and label the stored images based on a specific location where the image was captured.

2. The automatic categorization arrangement of claim 1 wherein the specific location processor comprises at least one location database for providing specific location identification.

3. The automatic categorization arrangement of claim 1 wherein the computer station includes a user interface for entering user information and requests.

4. The automatic categorization arrangement of claim 3 wherein the image processing service further comprises:
a code processing module configured to categorize and label stored images based on the stored image data and the user information and requests.

5. The automatic categorization arrangement of claim 3 wherein the stored image data includes time data indicating the time and date at which an image was captured and the code processor is configured to categorize the images based on the time data.

6. The automatic categorization arrangement of claim 1 wherein the computer station is remote from the digital camera and is automatically accessible through wireless connections.

7. The automatic categorization arrangement of claim 1 wherein the computer station is a personal computer.

8. A method for categorizing images stored in a digital camera using a categorizing arrangement, the method comprising:
downloading the stored images and associated image data into the categorizing arrangement;
identifying specific locations where images were captured; and
categorizing and labeling the images based on the specific locations where the images were captured.

9. The method of claim 8 further including the step of downloading user information and requests into the categorizing arrangement.

10. The method of claim 9 wherein the images are further categorized and labeled based on the associated image data and the user information and requests.

11. The method of claim 10 wherein the associated image data includes time data indicating the date and time at which each stored image was captured and the further categorizing is based on the time data.

12. The method of claim 11 further including the step of determining activities performed at the date and time that the images were captured at the identified specific locations.

13. The method of claim 10 wherein the further categorizing of the images based on the specific locations, the associated image data, and the user information and requests are performed in a user requested hierarchy.

14. The method of claim 10 wherein the user information and request includes display data for displaying the images after categorization.

15. The method of claim 10 wherein the user information and requests include e-mail data for e-mailing specified images to specified email locations.

16. The method of claim 10 wherein the user information and request includes fax data for faxing specified images to specified fax numbers.

17. An automatic image categorization system, the system comprising:
a computer station;
a digital camera connectable to the computer station, the digital camera having images and associated image data stored therein;
a network connected to the computer station; and
an image processing service connected to the network, wherein the image processing service comprises a specific location processor configured to identify and categorize the images based on the specific location where the image was captured.

18. The system of claim 17 wherein the digital camera comprises:
a computer station interface module for connecting the digital camera to the computer station;
a user interface module for entering user information and requests;
an optics module for capturing the images;
a GPS module for providing general location data;
a memory module for storing the images and the image data; and
a controller for controlling the operations of the camera.

19. The system of claim 18 wherein the specific location processor comprises at least one location database for providing specific location identification.

20. The system of claim 19 wherein the image processing service further comprises:
a code processor configured to process the stored images in categories based on the stored image data and the user information and requests.
